(19) United States
(12) Patent Application Publication
(10) Pub. No.: US 2008/0041414 A1
(43) Pub. Date: Feb. 21, 2008

(54) Pump Cleaning

(76) Inventor: Jeremy Daniel McKendrick Watson, Worthing (GB)

Correspondence Address: THE BOC GROUP, INC., 575 MOUNTAIN AVENUE, MURRAY HILL, NJ, 07974-2064, US

(21) Appl. No.: 11/630,878

(22) PCT Filed: Jul. 6, 2005
(86) PCT No.: PCT/GB05/02646

§ 371 Date: Dec. 22, 2006

(30) Foreign Application Priority Data
Jul. 12, 2004 (GB) 0415560.2

(51) Int. Cl. B08B 6/00

(52) U.S. Cl. 134/1.1; 134/166 R

(57) ABSTRACT

The invention relates to the cleaning of a pump used to evacuate a semiconductor process tool. During use of the pump, a reactant such as NF₃ is introduced into a foreline extending between the tool and the pump. A plasma generator located within the foreline generates from the NF₃ fluorine and/or fluorine radicals for cleaning the pump as they are conveyed therethrough.

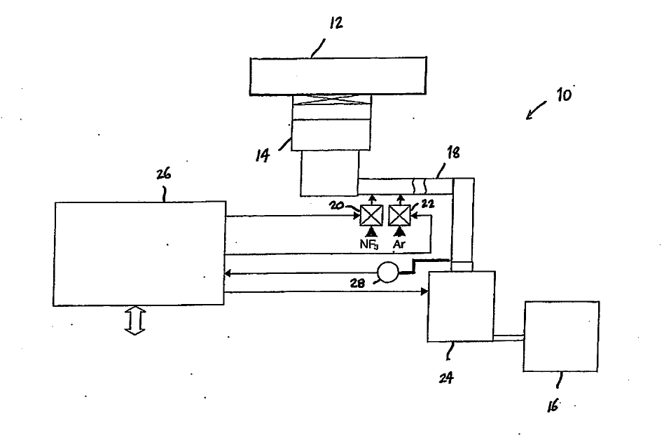

This invention relates to a system for cleaning a pump used to evacuate a semiconductor process chamber.

Vacuum pumping arrangements used to pump fluid from semiconductor tools typically employ, as a backing pump, a multi-stage positive displacement pump employing inter-meshing rotors. The rotors may have the same type of profile in each stage or the profile may change from stage to stage.

During semiconductor processes such as chemical vapour deposition (CVD) processing, deposition gases are supplied to a process chamber to form a deposition layer on the surface of a substrate. A variant of CVD, atomic layer deposition (ALD) has been considered to be an improvement in thin layer deposition in terms of uniformity and conformity, especially for low temperature deposition. In ALD processes, the residence time in the chamber of the deposition gas is relatively short, and only a small proportion of the gas supplied to the chamber is consumed during the deposition process. Consequently, a significant amount of unconsumed gas molecules is available to react outside the process chamber in locations such as in the process foreline and the backing pump. This can result in the deposition of high-density material on the rotor and stator elements of the pump. Furthermore, if the unconsumed process gas, or a by-product from the deposition process, is condensable, sublimation on lower temperature surfaces can result in the accumulation of powder or dust within the pump. If this accumulation of solid material continues unabated, it could eventually cause the pump motor to become overloaded, and thus cause the pump control system to shut down the pump. Furthermore, should the pump be allowed to cool down to ambient temperature, this accumulated material will become compressed between the rotor and stator elements. Due to the relatively large surface area of potential contact that this creates between the rotor and stator elements, such compression of the accumulated material can increase the frictional forces opposing rotation by an order of magnitude.

One technique for cleaning the backing pump is to inject a cleaning fluid into purge ports located about the stator. However, as the backing pump is typically a relatively large, floor standing pump, it tends to be located in a basement, and so relatively long runs of piping may be required to convey the cleaning fluid to the backing pump. Furthermore, where ALD processing is conducted within the process chamber, the cleaning fluid may need to react with the deposits in order to allow them to be flushed from the pump with the exhaust gases. For example, the cleaning fluid may comprise a fluorinated gas, such as CIF₃ or F₂. Clearly, for safety reasons, having relatively long runs of piping containing such a gas is not desirable.

It is an aim of at least the preferred embodiment of the present invention to seek to solve this and other problems.

In a first aspect, the present invention provides a method of cleaning a pump used to evacuate a semiconductor process tool, the method comprising introducing a reactant into a foreline used to convey an exhaust stream from the tool towards the pump, generating from the reactant one or more reactive species for cleaning the pump, and passing the reactive species through the pump.

By injecting the reactant into the foreline between the tool and the pump, and generating the reactive species from the injected reactant, the invention can permit cleaning of the pump without the need to provide special routing of cleaning fluid to the pump. This can reduce costs and improve safety.

By introducing the reactive species into the foreline, the reactive species may be generated at any convenient location between the point of introduction and the pump. As the pump may be a relatively large pump located in a basement, the reactant is preferably introduced into the foreline proximate, or adjacent, the tool. In contrast, the reactive species are preferably generated proximate, or adjacent, the pump, which both allows the reactant to be conveyed along a substantial part of the foreline in a less reactive and therefore relatively safe state, and also minimises the level of recombination of the reactive species to form the reactant before the reactive species reach the pump.

The reactive species may be periodically generated from the reactant as and when required to clean the pump. For example, a controller may be configured to monitor an operating characteristic of the pump, such as the current drawn by a motor of the pump, which may be indicative of the degree of blocking of the pump, and to cause the reactive species to be generated depending on the monitored characteristic, for example if the current drawn exceeds a predetermined amount. Other operating characteristics that may be monitored include, but are not limited to:
motor power
pump temperature
exhaust pressure
bearing vibration
   as variation in any of the above operating characteristics or any combination thereof could be used to indicate pump blockage.

Alternatively, or additionally, the controller may be configured to receive a signal indicative of the pressure within the foreline, and to cause the reactive species to be generated depending on the pressure within the foreline. From this signal, the controller may predict when the pump is likely to become blocked, and cause the reactive species to be generated accordingly to prevent blockage. For example, if the pressure within the foreline is relatively low, indicative of little or no exhaust fluid within the foreline, the period, and/or the duration, of the generation of the reactive species may be increased.

Alternatively, or additionally, the controller may be configured to receive a signal indicative of an operating characteristic of the process tool, and to cause the reactive species to be generated depending on the information contained within that signal. This information may relate to, for example, the pressure and temperature within the process chamber, gas flow rates, the loading condition of the chamber, and so on.

In a similar manner, the duration and/or period of the introduction of the reactive species into the foreline is preferably controlled according to one or more of an operating characteristic of the pump, an operating characteristic of the tool, and the pressure within the foreline.

In the preferred embodiment, the reactant is thermally decomposed to form the reactive species. A plasma generator located within the foreline is preferably used to strike a plasma for decomposing the reactant into the reactive species. The plasma is preferably generated from an inert ionisable gas, such as nitrogen and argon. To avoid having to provide relatively long runs of piping to convey the inert gas to the plasma generator, the inert gas is preferably introduced into the foreline.

In the preferred embodiment, the reactant comprises a source of fluorine, and the reactive species comprise fluorine (F₂ and/or F) and/or fluorine radicals (F*). Such species are particularly suitable for cleaning a pump used to evacuate an ALD processing tool. As a source of these species, the reactant preferably comprises a perfluorinated or hydrofluorocarbon compound, for example one of CF₄, C₂F₆, CHF₃, C₃F₈, C₄F₈, NF₃ and SF₆.

The reactant may be introduced into the foreline while the process tool is inactive, for example during maintenance, alternatively, which the process tool is active, that is, as an exhaust stream passes through the foreline towards the pump. This can assist in minimising tool downtime, as it is not necessary to halt the normal operation of the tool while the pump is cleaned. Thus, in a second aspect the present invention provides a method of cleaning a pump used to evacuate a semiconductor process tool, the method comprising introducing a reactant into an exhaust stream drawn from the tool by the pump, generating from the reactant within the exhaust stream one or more reactive species for cleaning the pump, and passing the exhaust stream and reactive species through the pump.

In a third aspect, the present invention provides apparatus for cleaning a pump for evacuating a semiconductor process tool, the apparatus comprising means for introducing a reactant into a foreline extending between the tool and the pump, and means located within the foreline for generating from the reactant one or more reactive species for cleaning the pump.

Features described above in relation to method aspects of the invention are equally applicable to apparatus aspects, and vice versa.

By way of example, an embodiment of the invention will now be further described with reference to the following FIGURE, which illustrates schematically a system 10 for evacuating a process chamber 12 of a semiconductor processing tool. In this embodiment, the tool is a deposition tool, for example, a chemical vapour deposition (CVD) tool or an atomic layer deposition (ALD) tool, for depositing one or more layers on to a substrate located within the chamber 12. However, the invention is applicable for use with any other form of semiconductor processing tool.

In this example, the evacuation system 10 comprises a booster pump 14, which may be mounted on the tool, and a backing pump 16 connected to the booster pump 14. The booster pump 14 may comprise a turbomolecular pump, and the backing pump 16 may comprise a dry pump having one or more of a Roots, Northey (“claw”) or screw-type pumping mechanism. The booster pump 14 is an optional component of the evacuation system 10; the backing pump 16 may be connected directly to the chamber 12 via foreline 18. Therefore, for the purposes of this specification, the foreline 18 comprises the entire flow path of an exhaust stream passing from the chamber 12 to the backing pump 16, with the booster pump 14 comprising an optional component within the foreline 18.

The backing pump 16 may output the exhaust fluid to an abatement system (not shown) for treating the exhaust fluid to remove any noxious fluids therefrom before it is exhaust into the atmosphere

During use, the foreline 18 conveys a stream of exhaust fluid output from the chamber 12 towards the backing pump 16. As, in this example, the tool is a deposition tool, a significant amount of unconsumed gas molecules are present within the exhaust fluid passing through the foreline 18 towards the backing pump 16. This can result in the deposition of high-density material within the running clearances between the rotor and stator elements of the backing pump 16. If this material is allowed to build up unabated, it could eventually cause the motor of the backing pump to become overloaded, and thus cause the pump control system to shut down the backing pump.

In view of this, the evacuation system 10 includes a system for periodically cleaning the backing pump 16 to remove such material therefrom. The cleaning system is arranged to introduce into the foreline 18 a reactant from which one or more reactive species are subsequently generated for reacting with the material deposited within the backing pump 16. In the illustrated embodiment, the evacuation system 10 comprises a first variable flow control device, such as a butterfly or other control valve 20, through which the reactant is introduced into the foreline 18 via a first fluid port located proximate the chamber 12. As shown, the reactant may be conveniently introduced downstream from any booster pump 14 located within the foreline 18, particularly where the booster pump 14 is mounted on the tool, or, alternatively, it may be introduced into the foreline upstream from the booster pump 14, particularly when the booster pump 14 is physically separate from the tool.

In this embodiment, the reactant is NF₃, which may be supplied to the valve 20 from any convenient source thereof, such as a gas cylinder. The reactive species are generated from the NF₃ reactant by a plasma generator 24 located within the foreline 18. An example of a suitable plasma generator 24 is the MKS Astron AX7680 (MKS ASTex Products, Wilmington, Mass.) or similar device that can generate from the NF₃ reactant fluorine (F₂ and/or F) and fluorine radicals (F*) as reactive species for reacting with the material deposited within the backing pump 16. As the more reactive fluorine radicals will tend to recombine to form F₂ within a fairly short distance, the plasma generator 24 is preferably located proximate the backing pump 16, as shown in the drawing, to maximise the likelihood of the fluorine radicals reaching the internal components of the backing pump 16.

Within the plasma generator 24, the NF₃ reactant is conveyed through a plasma generated from an inert, ionisable gas, such as nitrogen or, as in the illustrated embodiment, argon, which causes the reactant to thermally decompose into the reactive species. In this embodiment, rather than providing separate piping or conduits for conveying the inert gas to the plasma generator 24, the inert gas is introduced into the foreline 18 upstream from plasma generator 24. As illustrated, the evacuation system 10 comprises a second variable flow control device, such as a butterfly or other control valve 22, through which the inert gas is introduced into the foreline 18 via a second fluid port located proximate the chamber 12.

A controller 26 is provided for controlling the operation of the first and second control valves 20, 22 and the plasma generator 24. In order to initially strike the plasma within the plasma generator 24, the controller 26 controls the second control valve 22 to supply the inert gas to the foreline 18 before either the reactant or the exhaust fluid is present in the foreline 18, for example, while the process tool is idle. For example, both the first and the second control valves 20, 22 may have a conductance that is variable in dependence on information contained within a signal received from the controller 26. Once the plasma has been struck within the plasma generator 24, the conductance of the second control valve 22 may be controlled so that there is always sufficient inert gas being supplied to the foreline 18 to maintain the plasma, when required, within the plasma generator 24.

The controller 26 is preferably configured to operate the first control valve 20 and the plasma generator 24 so that reactant is introduced into the foreline 18, and the reactive species are generated from the reactant, as and when cleaning of the backing pump 16 is required. The reactant may be introduced into the foreline either while the process tool is idle, so that pump cleaning can be synchronised with the downtime of the process tool, or it may be introduced into the foreline while the process tool is active, so that a mixture of the exhaust fluid from the chamber 12 and the reactive species is passed through the backing pump 16 during operation thereof.

The operation of the first control valve 20 and the plasma generator 24 may be controlled in dependence on one or more operational parameters of the system 10. These include, but are not limited to, an operating characteristic of the backing pump 16, an operating characteristic of the tool, and the pressure within the foreline 18. For example, the controller 26 may be configured to receive signals from the controllers of the backing pump 16 and the tool indicative of the status or other parameter relating to the backing pump 16 and the tool, and to control the first control device 20 and the plasma generator accordingly. As illustrated, the controller 26 may also receive a signal from a pressure sensor 28 indicative of the pressure within the foreline 18. From these signals, the controller 26 can determine the state of blockage of the backing pump 16, and the current and future deposition rates of material within the backing pump 16, and optimise the intensity of the cleaning of the backing pump 16 accordingly. For example, the controller 26 may control the period and/or duration of the introduction of the reactant into the foreline 18, and/or the period and/or duration of the generation of the reactive species from the reactant in response to the received signals. This can avoid unnecessary supply of reactant, and the unnecessary generation of the reactive species from the reactant, when the backing pump 16 is relatively clean and the deposition rate of material within the backing pump 16 is relatively low, thereby reducing costs.

1. A method of cleaning a pump used to evacuate a semiconductor process tool, the method comprising introducing a reactant into a foreline used to convey an exhaust stream from the tool towards the pump, generating from the reactant one or more reactive species for cleaning the pump, and passing the reactive species through the pump.

2. The method according to claim 1 wherein the reactive species are generated adjacent the pump.

3. The method according to claim 1 wherein the duration and/or period of the generation of the reactive species from the reactant is controlled according to one or more of an operating characteristic of the pump, an operating characteristic of the tool, and the pressure within the foreline.

4. The method according to claim 1 wherein the reactant is thermally decomposed to form the reactive species.

5. The method according to claim 4 wherein the reactant is thermally decomposed by a plasma.

6. The method according to claim 5 wherein the plasma is generated from an inert ionisable gas.

7. The method according to claim 6 wherein the inert gas is one of nitrogen and argon.

8. The method according to claim 6 wherein the inert gas is introduced into the foreline separately from the reactant.

9. The method according to claim 8 wherein the inert gas is introduced into the foreline before the reactant.

10. The method according to claim 1 wherein the reactant comprises a source of fluorine, and the reactive species comprise fluorine and/or fluorine radicals.

11. The method according to claim 10 wherein the reactant comprises a perfluorinated or hydrofluorocarbon compound.

12. The method according to claim 10 wherein the reactant comprises one of F₂, CF₄, C₂F₆, CHF₃, C₃F₈, C₄F₈, NF₃ and SF₆.

13. The method according to claim 1 wherein the duration and/or period of the generation of the reactive species from the reactant is controlled according to one or more of an operating characteristic of the pump, an operating characteristic of the tool, and the pressure within the foreline.

14. The method according to claim 1 wherein the reactant is introduced into the foreline proximate or adjacent the tool.

15. The method according to claim 1 wherein the reactant is introduced into the foreline as the exhaust stream passes therethrough towards the pump.

16. A method of cleaning a pump used to evacuate a semiconductor process tool, the method comprising introducing a reactant into an exhaust stream drawn from the tool by the pump, generating from the reactant within the exhaust stream one or more reactive species for cleaning the pump, and passing the exhaust stream and reactive species through the pump.

17. Apparatus for cleaning a pump for evacuating a semiconductor process tool, the apparatus comprising means for introducing a reactant into a foreline extending between the tool and the pump, and means located within the foreline for generating from the reactant one or more reactive species for cleaning the pump.

18. The apparatus according to claim 17 wherein the generating means is located adjacent the pump.

19. The apparatus according to claim 17 comprising control means for controlling the period and/or duration of operation of the generating means.

20. The apparatus according to claim 19 wherein the control means is arranged to control the period and/or duration of operation of the generating means in dependence on one or more of an operating characteristic of the pump, an operating characteristic of the tool, and the pressure within the foreline.

21. The Apparatus according to claim 19 wherein the control means is arranged to control the period and/or duration of the introduction of the reactant into the foreline in dependence on one or more of an operating characteristic of the pump, an operating characteristic of the tool, and the pressure within the foreline.

22. The apparatus according to claim 17 wherein the generating means is arranged to thermally decompose the reactant to form the reactive species.

23. The apparatus according to claim 17 wherein the generating means comprises a plasma generator.

24. The apparatus according to claim 23 comprising means for introducing into the foreline an inert ionisable gas for generating the plasma.

25. The apparatus according to claim 24 wherein the inert gas is one of nitrogen and argon.

26. The apparatus according to claim 17 wherein the reactant comprises a source of fluorine, and the reactive species comprise fluorine and/or fluorine radicals.

27. The apparatus according to claim 26 wherein the reactant comprises a perfluorinated or hydrofluorocarbon compound.

28. The apparatus according to claim 26 wherein the reactant comprises one of F₂, CF₄, C₂F₆, CHF₃, C₃F₈, C₄F₈, NF₃ and SF₆.
